(19) United States
(12) Patent Application Publication
(10) Pub. No.: US 2003/0102329 A1
(43) Pub. Date: Jun. 5, 2003

(54) Dispenser

(76) Inventor: Joong Hyun Ki, Incheon (KR)

Correspondence Address: BACON & THOMAS, PLLC, 625 SLATERS LANE, FOURTH FLOOR, ALEXANDRIA, VA, 22314

(21) Appl. No.: 10/244,001

(22) Filed: Sep. 16, 2002

(30) Foreign Application Priority Data
Dec. 5, 2001 (KR) 2001-37543

(51) Int. Cl. B67D 5/56; B67D 5/40

(52) U.S. Cl. 222/129; 222/321.9

(57) ABSTRACT

The invention relates to a dispenser of new construction in which different components stored separately can be readily mixed.

The invention is a dispenser including a main container 2 for storing the first contents, a dispenser cap 10 coupled to the top of the main container 2, wherein the dispenser further includes an auxiliarly container 20 for storing the second contents and provided with a bottom sheet 22 rupturable by pressing, the auxiliarly container being provided between the main container 2 and the dispenser cap 10, a spacer member 30 disposed on the top circumference of the auxiliarly container 20, the spacer member being removable at the time of service of the dispenser, and a push member 40 disposed inside the auxiliary container 20 so as to entirely rupture the bottom sheet 22 of the auxiliary container 20 by falling on removal of the spacer member 30, wherein pressing the push member 40 after removal of the spacer member 30 can cause opening of the bottom sheet 22 of the auxiliary container 20 so as to cause the second contents stored in the auxiliary container 20 to mix with the first contents stored in the main body 2.

### FIELD OF THE INVENTION

The present invention relates to a dispenser and more particularly to a dispenser of new construction in which different components stored separately can be readily mixed.

### BACKGROUND OF THE INVENTION

Some of the cosmetics are originally designed so that base components in paste state are mixed, at the time of use, together with the powder components usually for a specific purpose like so-called beauty whiteness effect. Such cosmetics are provided in cosmetic containers as described in FIG. 1 in which the base component and powder component are separately stored so as to be mixed together only at the time of use because otherwise the components may be easily deteriorated with time.

Referring to FIG. 1 showing such a conventional cosmetics container, by way of illustration, an auxiliarly container 3 for storing a powder component is coupled to the top of a main container 3 for storing a base component and a push cap 4 is provided with a push bar 5 bing forced elastically by means of a spring 9 such that pressing the push bar 5 may cause it to be lowered to break the bottom 6 of the auxiliary container 3. Thus, at the moment of using cosmetics, pressing the push bar 5 could cause the base component to mix the powder component stored in the auxiliary container 3, as the powder would drop as the result of the breakage of the bottom sheet 6 of the container 3. However, there is a flaw with this conventional cosmetics container in that a part of the powder component is left and hardened there in the auxiliary container 3 even after the breakage of the bottom sheet 6 by the push bar 5, as the sheet usually fails to be cut away entirely, whereby loss of the powder component ensues.

On the other hand, such a cosmetics container is usually accompanied by a separate dispenser cap beside the above-described push cap 4 to form a set, which dispenser cap is intended to serve to discharge an amount of the contents as desired. Thus, after the step of mixing the powder component and base component by use of the push cap 4, the push cap is removed and the dispenser cap is attached to the main container 2 to prepare for dispensing the product contents. The need for shifting to the dispenser cap from the push cap 4 represents an inconvenience in use on one side and a risk of deteriorating the contents on the other hand due to the inflow of air into the main container 2 during the shifting step. Further, the need for two types of caps elevates the cost of the product.

### SUMMARY OF THE INVENTION

In order to overcome the above-described problem with the conventional art, the present invention is intended to provide a dispenser of new design, which allows not only mixing of two components separately stored but also dispensing the mixed contents in any desired portions of amount so as to increase the convenience in use as well as the material efficiency resulting from no loss of the components.

The suggested object is achieved according to an aspect of the invention by a dispenser including a main container 2 for storing the first contents, a dispenser cap 10 coupled to the top of the main container 2, wherein the dispenser further includes an auxiliarly container 20 for storing the second contents and provided with a bottom sheet 22 rupturable by pressing, the auxiliarly container being provided between the main container 2 and the dispenser cap 10, a spacer member 30 disposed on the top circumference of the auxiliarly container 20, the spacer member being removable at the time of service of the dispenser, and a push member 40 disposed inside the auxiliary container 20 so as to entirely rupture the bottom sheet 22 of the auxiliary container 20 by falling on removal of the spacer member 30, wherein pressing the push member 40 after removal of the spacer member 30 can cause opening of the bottom sheet 22 of the auxiliary container 20 so as to cause the second contents stored in the auxiliary container 20 to mix with the first contents stored in the main body 2.

According to another aspect of the invention, the bottom sheet 22 of the auxiliarly container 20 is provided with radial weak lines 26, and the push member 40 is formed in the form of a cylinder corresponding to the bottom sheet 22 of the auxiliarly container 20 such that the bottom sheet 22 is cut out along the weak lines 26 when the push member 40 presses down the circumferential area of the bottom sheet 22.

### BRIEF DESCRIPTION OF THE DRAWINGS

FIG. 1 shows a conventional cosmetics container

FIGS. 2 and 3 show respectively the dispenser according to the embodiment of the invention in cross section and in service

FIG. 4 shows the bottom sheet of the embodiment of the invention

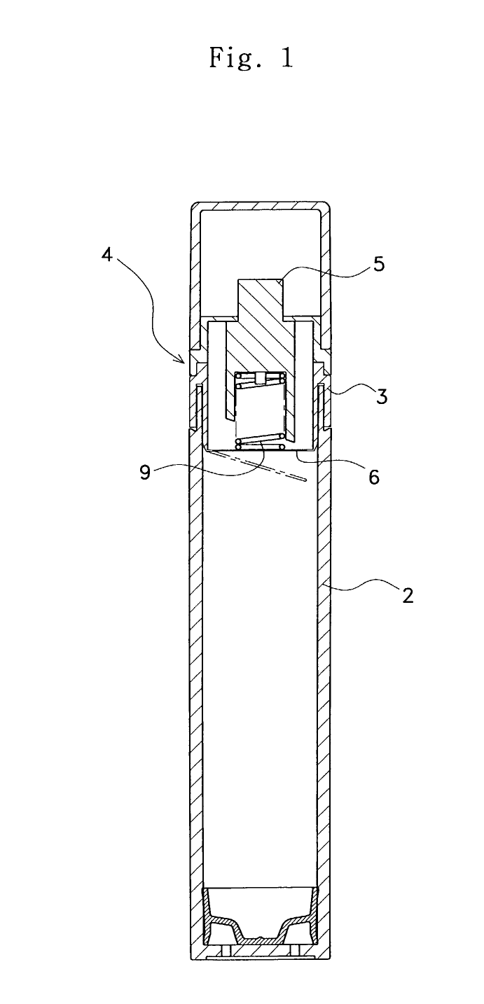

### DETAILED DESCRIPTION OF THE INVENTION

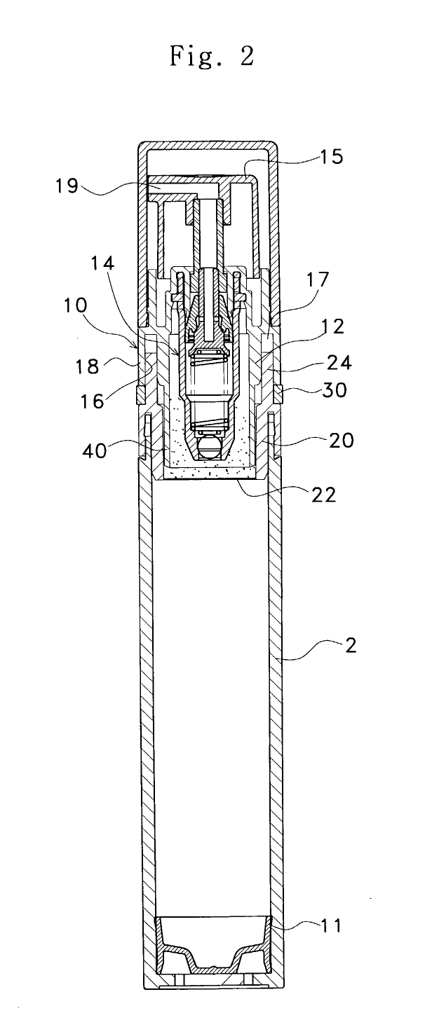

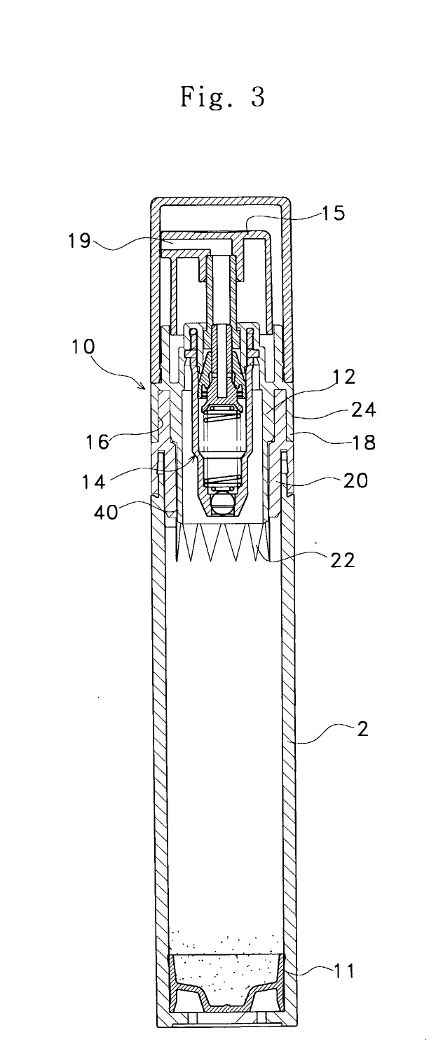

A preferred embodiment of the invention is described in detail below by referring to the accompanying drawings. FIGS. 2 and 3 show respectively the dispenser according to the invention in cross section and in service. The embodiment relates to an airless type dispenser including a main container 2 for storing the first contents and a dispenser cap 10 for discharge the contents.

The main container 2 in which the first contents as the base component are stored is provided with a piston 11 which travels upward along the inner wall of the main container 2 as the contents are discharged. On the top side of the main container 2, an auxiliarly container 20 containing a powder-formed second contents is fixed, wherein the bottom sheet 22 of the auxiliarly container 20 is so formed as to be easily broken by pressing impact. On the top of this auxiliarly container 20, a spacer member 30 in the form of a band is provided. Preferably, the spacer member 30 of a weak line or strip is formed around and integrally with the top circumference of the auxiliary container 20 to form a demarcation, so that this spacer member 30 may be removed in the form of a band when this weak line is torn along the top circumference of the auxiliarly container 20 at the time of use.

Further, a dispenser cap section 10 is provided on the top of this spacer member 30. This dispenser cap section 10 comprises a cap 12 connected to the top part of the auxiliarly container 20, a pumping section 14 and a button section 15. Thus, as the button section 15 is pressed, the pumping section goes into operation so as to cause the contents in this section to discharge through a spouting opening 19 formed at a side of the button section 15. In connecting the cap 12 of the dispenser cap section 10 to the auxiliary container 20, the top part of the cap 12 is so formed as to bend down to form an inverted U together with so-formed upright part 18, as shown in FIG. 2, whereby a groove 16 in cylinder form results under the lower circumference of the cap 12 so as to receive a protrudent part 24, which is formed upright integrally on the top rim of the auxiliarly container 20 inside the spacer member 30.

When the dispenser cap section 10 is connected to the auxiliarly container 20 in such a manner that the protrudent part 24 of the auxiliarly container 20 is inserted in the groove 16 of the cap 12, an empty space 17 remains in the upper section of the interior of the groove 16, because the protrudent part 24 is prevented from entire insertion into the interior of the groove 16 when the bent member 18 of the cap 12 rests on the top edge of the spacer member 30. When the spacer member 30 is removed and the cap 12 of the dispenser cap section 10 is pressed down to use the cosmetic suspension, the dispenser cap section 10 can fall through a distance a little longer than the height of the spacer member 30, so that the protrudent part 24 can fully enter the groove 16, with the bottom of the push member 40 just passing the bottom of the auxiliarly container 20.

On the other hand, the dispenser cap section 10 is provided, at its lower part, with a push member 40 so as to rupture the bottom sheet 22 of the auxiliarly container 20. Preferably, the push member 40, the bottom edge of which is sharp, is formed integrally with the bottom part of the cap 12. Therefore, when the dispenser cap section 10 is pressed down, with the help of a hand for example, after removal of the spacer member 30, with the intention of mixing the separated contents, the dispenser cap section 10 is lowered enough, so that the push member 40 with its sharp edge may press the bottom sheet 22 of the auxiliarly container 20 to rupture the bottom sheet.

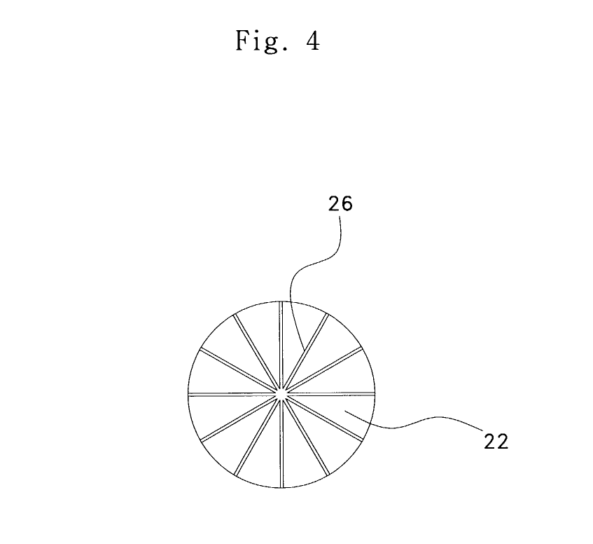

In addition, the bottom sheet 22 of the auxiliarly container 20 is preferably provided with weak lines 22 arranged radially to guide and induce easy rupture, as shown in FIG. 4. The push member 40 is formed as a cylinder having the outer circumferential surface corresponding to the inner circumferential surface of the auxiliarly container 20, so that the push member 40 may press the circumferential area of the bottom sheet 22 of the auxiliarly container 20. Accordingly, the bottom sheet 22 of the auxiliarly container 20. can be opened completely along the weak lines 26 approximately as shown in FIG. 3, with the result that the second contents in the auxiliarly container 20 can, as its entirety without any residue, enter the main container 2 to mix with the first contents therein.

As described above, a single dispenser cap 10 according to the invention can perform both the function of mixing the first and second contents and the function of dispensing the contents, mixed or unmixed, in any desired quantities, resulting in cost reduction and increased convenience as well as invariably high quality product.

1. A dispenser including a main container 2 for storing the first contents, a dispenser cap 10 coupled to the top of the main container 2, wherein the dispenser further includes an auxiliarly container 20 for storing the second contents and provided with a bottom sheet 22 rupturable by pressing, the auxiliarly container being provided between the main container 2 and the dispenser cap 10, a spacer member 30 disposed on the top circumference of the auxiliarly container 20, the spacer member being removable at the time of service of the dispenser, and a push member 40 disposed inside the auxiliary container 20 so as to entirely rupture the bottom sheet 22 of the auxiliary container 20 by falling on removal of the spacer member 30, wherein pressing the push member 40 after removal of the spacer member 30 can cause opening of the bottom sheet 22 of the auxiliary container 20 so as to cause the second contents stored in the auxiliary container 20 to mix with the first contents stored in the main body 2.

2. A dispenser of claim 1, wherein the bottom sheet 22 of the auxiliarly container 20 is provided with radial weak lines 26, and the push member 40 is formed in the form of a cylinder corresponding to the bottom sheet 22 of the auxiliarly container 20 such that the bottom sheet 22 is cut out along the weak lines 26 when the push member 40 presses down the circumferential area of the bottom sheet 22.
